(19) United States
(12) Patent Application Publication
(10) Pub. No.: US 2014/0291272 A1
(43) Pub. Date: Oct. 2, 2014

(54) INFANT FEEDING BOTTLE

(71) Applicants: Daniel Weil, London (GB); Paul Walker, Watford (GB); Neil Williams, Watford (GB); Heiko Li, Kunshan City (CN)

(72) Inventors: Daniel Weil, London (GB); Paul Walker, Watford (GB); Neil Williams, Watford (GB); Heiko Li, Kunshan City (CN)

(73) Assignee: Mothercare UK Limited, Watford (GB)

(21) Appl. No.: 14/116,579

(22) PCT Filed: May 11, 2012
(86) PCT No.: PCT/IB2012/052350

§ 371 Date: May 15, 2014

(30) Foreign Application Priority Data
May 13, 2011 (GB) 1108049.6

(51) Int. Cl. A61J 11/02

(52) U.S. Cl. CPC A61J 11/02
USPC 215/11.5

(57) ABSTRACT

A feeding bottle (10) comprises a container (12) having a threaded neck (22) around an opening of the container, a teat (16), and, a threaded annular collar. The teat has a flange (84), adapted to seat on said neck, a nipple (88), remote from the flange, and a one-way valve (110) formed in a depression (112) in the teat to allow the passage of air into the container but prevent leakage of liquid from the container through the valve. The collar is adapted to receive the teat through the aperture (56) of the collar. The depression (112) is provided with an upstanding flange (114) above the surface of the teat where the depression (112) joins a main surface of the teat, which flange (114) serves to protect the depression (112) against deformation of the main surface of the teat.

### CROSS-REFERENCE TO RELATED APPLICATIONS

The present application is a national phase application of PCT application PCT/IB2012/052350 filed May 11, 2012, which claims the priority benefit of Great Britain patent application 1108049.6 filed May 13, 2011, the disclosures of which are incorporated herein by reference.

### TECHNICAL FIELD

This invention relates to infant feeding bottles and teats therefor.

### BACKGROUND

Traditionally, babies' feeding bottles comprise: a container, having an open neck with screw threads formed around the neck adjacent the opening; a collar, that is screw-threaded to screw onto the screw threads of the container neck, which collar is annular; and a teat, having a flange adapted to be trapped between a rim of the collar and the top edge of the neck, whereby a fluid-tight seal between the container and the teat can be effected. A nipple is arranged on the teat remote from the flange and has a feed opening at the end of the nipple adapted to dispense feed when contained in the bottle.

It is known to incorporate a one-way valve in the teat, generally near the flange and sometimes so as to be covered by the shoulder, whereby air is permitted to enter the bottle if the pressure inside the bottle drops during feeding due to liquid feed being dispensed through the feed opening of the teat. This may assist prevention of colic in a feeding baby, or possibly the ingestion of air by the baby.

EP-A-397282 discloses a valve integrally formed on the teat but it interacts with a surface of the collar to form the valve. DE-U-29906849 and WO-A-2006/103379 disclose an integral, stand-alone valve in the teat, formed from the same material as the teat.

Ideally, such valves should not be submerged by the liquid feed during feeding, but this is generally not feasible because the feed usually completely fills the teat during inversion of the bottle for feeding purposes. Consequently, it is important that the valve is liquid tight, so that liquid feed does not leak out. The valve is conveniently formed of a slit in a depression of the teat remote from its main opening in the nipple. However, during feeding, the teat is frequently deformed and there is a risk that the valve is disrupted, causing a potential leak problem. One way of avoiding this problem is to make the depression of great depth so that the slit at the bottom of the depression is so remote from the remainder of the teat that deformations of the teat cannot affect the valve.

WO-A-2006/103379 mentions this problem, which is that flexing at the surface of the teat may disturb the efficacy of the seal. It points out that it is necessary to have the depression (at the bottom of which is the seal) deep enough to isolate the seal from such disturbances. U.S. Pat. No.5,678,710 uses a long stemmed depression at the base of which is the valve. US-A-2009/019430 discloses a thickening around the depression adjacent the valve that serves to reinforce an area around the valve and presumably further isolates the valve from the remainder of the teat. Such arrangements are not particularly attractive.

Bottles generally need to contain a similar quantity of feed (unless they are travel bottles for “snack” size feeds). In the past, bottles have been tall and thin. However, more recently, the trend has been towards short and wide bottles, that are perhaps easier to clean, or have more stability or simply have a more attractive design appearance. With tall thin bottles, the container is frequently round in cross-section, with the neck being concentric with the remainder of the bottle. The collar frequently has the same section in all planes parallel to the axis of its annulus (with the exception of the thread, of course). The teat is also usually rotationally symmetrical with the nipple thus being central. Thus the container, collar and teat are all symmetrical about a common longitudinal axis.

With the advent of short, squat containers, two developments have occurred. The first is the formation of depressions in the sides of the container to reduce the girth of the bottle in at least one plane so as to facilitate grasping. The second is an eccentric nipple in the teat. With narrow bottles and a central nipple, the top edge of the container does not restrict the angle of tilt that can be achieved with respect to an infant's mouth. However, as the girth increases the distance to the edge from the centre line of the bottle can become problematic.

Indeed, JP-A-2000-288 suggests that an eccentrically disposed nipple can assist the transition from a peristaltic feeding action (that is instinctive in the newborn baby) to a sucking action that develops a few months after birth. The parent or guardian is supposed to offer a particular orientation of the teat (i.e. with the nipple downmost) in the early months and then transition to an orientation in which the nipple is uppermost. The aspects “uppermost” and “downmost” are with respect to the longitudinal axis of the bottle. CN-Y-2877685 also discloses an eccentric nipple on the teat.

The present invention seeks to provide a bottle that combines several of the aforementioned features in an effective way that does not suffer from or at least mitigates some of the disadvantages of prior art designs.

### SUMMARY OF THE PRESENTLY CLAIMED INVENTION

In accordance with the present invention there is provided a feeding bottle comprising:

a container, having a longitudinal axis and a neck around an opening of the container, wherein the neck comprises a first connector part and has a neck axis;

a teat, having:
a flange, adapted to seat on said neck around the neck opening and having a flange axis to coincide with said neck axis when the teat is seated on the neck;
a nipple, remote from the flange,
a feed opening at the end of the nipple adapted to dispense feed when contained in the bottle, and

an annular collar, having:
an aperture adapted to receive said teat,
a second connector part, and,
a rim around said aperture adapted to press said flange against said neck to seal the teat with respect to the container when said first and second connector parts are interengaged with one another to connect the collar to the container,
   characterised in that

a) the container has no more than two preferred planes of grip, which planes contain said longitudinal axis;

b) the nipple has a nipple axis that is not concentric with the flange axis;

c) the teat and collar have between them means to locate the teat in the collar in only as many angular orientations of the flange axis with respect to the neck axis as there are planes of grip of the container; and

d) the first and second connector parts are so arranged that, when interengaged and the bottle is assembled, the nipple axis is contained in said plane of grip or one of them.

By “plane of grip” is meant an identifiable plane of the container that the shape or surface features of the container encourages a user to adopt in relation to a typical hand that grips the bottle for use. A hand gripping an object defines (somewhat approximately) a “hand plane” between the U-shaped arrangement of the thumb and fingers, which hand plane is parallel the arms of the U-shape and the juxtaposed fingers. The plane of grip of an object is the plane through it that is parallel to the hand plane and depends entirely on the user and the orientation of the bottle in the user's hand when grasping the container. Clearly a round-section object has an infinite number of grip planes, any one of which may be parallel the hand plane when the object is grasped by the user. It therefore has no preferred planes of grip. An object has a “preferred plane of grip” if its shape causes the user (normally subconsciously) to adopt a particular orientation of the object into the hand plane. Thus, one such shape is the provision of indentations on two opposite sides of the container that reduce the girth of the container across the indentations, the ergonomics of which invite and lead the user to locate their thumb in one indentation and their fingers in the other indentation on the other side of the bottle, whereby the user's grip is more secure and requires less separation between thumb and fingers. In that event, the grip plane of the container is the plane between the indentations. Another shape is the section of the container being arranged oval or elongate, so that the container is thinner in one plane than the other. Another aspect is the provision of grip areas along two sides of the container, which again encourages a user to adopt a particular orientation of the container in their hand during use.

If a container has identifiable planes of symmetry, it is most likely that the plane of grip of the container will lie in at least one of the planes of symmetry. It is entirely natural that infant feeding bottles, like many other designed objects, display aspects of symmetry, if only for aesthetic design purposes. Where a container displays a preferred plane of grip, this is to be taken as being coincident with a plane of symmetry of the container, provided that the plane of symmetry in question is no more than 45 degrees rotated from the actual plane of grip. In other words, most planes of grip of a bottle (including preferred such planes) are contained in a plane of symmetry of the bottle, which thereby identifies the grip plane.

For example, a square section container has four planes of symmetry, but only two preferred planes of grip, being those parallel the sides of the container. It is feasible that people may grip a square section bottle across the corners, but this has to be considered unlikely. A rectangular section container would have only one plane of grip, being that parallel the long sides of the container.

It is feasible to design a bottle that has a preferred plane of grip, but no planes of symmetry. For example, an oval section bottle could have on one side four elongate parallel indentations to encourage placing of the fingers, and on the other side just one, slightly larger indentation to encourage placement of the thumb. Indeed, some “designer” containers could have an identifiable preferred plane of grip but be quite irregular in shape.

Finally, while the container may have two planes of grip, once the collar and teat have been assembled, the position of the nipple on the teat will itself affect the resultant preferred plane of grip of the bottle. That is to say, if a container was square in section and thus had two preferred planes of grip with the nipple being positionable with respect to either of them, the preferred plane of grip of the assembled bottled would be the preferred plane of grip of the container that contained the nipple axle when assembled.

What technical advantage this design brings can be stated as follows:

the eccentric nipple means that the nipple can be close to one edge of the bottle, making feeding easier due to the angle at which the bottle is held to feed (generally about 35 degrees to the horizontal, whereby the teat is always full of milk until the container is nearly empty);

since the container has a limited number of planes of grip, the bottle is most comfortably held by a user in specific orientations with respect to the user's hand (and preferably just one); and

to ensure the nipple is in said plane of grip, the teat is in the collar in a fixed orientation, and the collar likewise connects to the container in (preferably, just) one orientation.

Preferably, said first and second connector parts are screw threads, the neck and collar being circular. Preferably the flange is also circular, the neck, collar and teat, when connected together, typically sharing a common thread axis. However, alternative connection mechanisms are within the scope of the person skilled in the art, provided they are capable of permitting the collar to be arranged on the container in a specific angular orientation, whereby the teat in the collar can itself be arranged with the particular angular orientation with respect to the container. For example, the collar may be a snap fit on the neck of the container and have single orientation possibility. Other arrangements include a bayonet type fitting, although that is also another form of simple screw thread.

Preferably, said means to locate the teat in the collar comprises said teat having an upstanding shoulder shaped to fit against said aperture of the collar, which shoulder and aperture are non-circular, so that the teat only fits in the collar, with said shoulder abutting the edge of said aperture, in as many angular orientations of the teat in the collar with respect to said flange axis as there are preferred planes of grip of the container. Again, preferably, (that is, not essentially) there is just one such possible orientation.

Said shoulder preferably does not lie in a single plane. Preferably, the shoulder is annular surrounding the nipple and has an approximate shoulder axis, and sectors of the shoulder around said shoulder axis. Preferably, said means to locate the teat in the collar comprises said sectors lying in planes inclined with respect to one another. One sector may be a flat sector around the nipple lying in a plane substantially orthogonal to the neck axis and another being an inclined sector remote from the nipple lying in a plane inclined with respect to the neck axis. The shoulder axis is approximate because, with a lack of symmetry between its sectors, it may be impossible to define a precise axis.

This difficulty in being precise with respect to axes (and indeed, planes) potentially applies to all the axes (and planes) described in this specification. Any one of them may be only “approximate” if the subject to which they refer lacks sufficient symmetry by which to precisely define the axis (or plane) in question.

Preferably, the container has only one plane of grip, caused by opposite depressions in either side of the container adapted to reduce a grip span of the container, the nipple being positioned in the plane between the depressions. The “grip span” is the maximum dimension that a hand has to be opened in order to grip the container across its longitudinal axis.

Preferably, the container is oval in section with flattened sides. Preferably, said neck is at a first end of a top side of the container, which top-side is oval-shaped matching said oval section.

Preferably, said teat includes:

a one-way valve formed in the teat to allow the passage of air into the container but prevent leakage of liquid from the container through the valve,

wherein the valve is positioned in the plane containing the nipple axis and flange axis on the side of the flange axis remote from the feed opening of the nipple.

Preferably, said teat includes:

a depression in a main surface of the teat between the flange and the nipple, said valve being integral with the teat and being disposed in said depression.

Preferably, the depression is inside said aperture of the collar when the bottle is assembled and is provided with an upstanding flange above the surface of the teat where the depression joins the main surface of the teat, which flange serves to protect the depression against deformation of the main surface of the teat.

Preferably, the collar has a scallop in the edge of the aperture that is arranged to partially surround the upstanding flange. Indeed, the scallop and upstanding flange may (additionally) serve as said means to locate the teat in the collar in only as many angular orientations of the flange axis with respect to the thread axis as there are planes of grip of the container.

Preferably, said scallop is central to said inclined sector of the shoulder.

Preferably, the collar has an external flange, which may cover the other of said top side of the container. Typically, said collar can rotate on the neck through at least 20 degrees without the external flange overlapping beyond said top side of the container. The external flange may have a flange detent and the container has a corresponding container detent, and wherein, when the collar is screwed onto the neck with the teat in place in the collar, the detents interlock. They interlock when the nipple is positioned in said preferred plane of grip, or one of them.

Preferably, when the container is oval in section with flattened sides and said threaded neck is at a first end of said oval section, the external flange of the collar overlies a shoulder of the container at a second end of said oval section, said container detent being on the container shoulder.

In accordance with another aspect of the present invention there is provided a feeding bottle comprising:

a container, having a longitudinal axis and a neck around an opening of the container, wherein the neck comprises a first connector part and has a neck axis;

a teat, having:
a flange, adapted to seat on said neck and having a flange axis to coincide with said neck axis when the teat is seated on the neck;
a nipple, remote from the flange,
a feed opening at the end of the nipple adapted to dispense feed when contained in the bottle,
a depression in a main surface of the teat between the flange and the nipple, and
a one-way valve formed in the teat in the depression to allow the passage of air into the container but prevent leakage of liquid from the container through the valve; and,

an annular collar, having:
an aperture adapted to receive said teat,
a second connector part, and,
a rim around said aperture adapted to press said flange against said neck to seal the teat with respect to the container when said first and second connector parts are interengaged with one another to connect the collar to the container,
characterised in that
   the depression is inside said aperture when the bottle is assembled and is provided with an upstanding flange above the surface of the teat where the depression joins a main surface of the teat, which flange serves to protect the depression against deformation of the main surface of the teat.

As with the aspect first defined above, preferably, said first and second connector parts are screw threads.

Preferably, the aperture of the collar has a scallop in its edge adapted to receive said upstanding flange. Preferably, positioning means ensures that the teat only fits in the collar in one angular orientation of the teat about said flange axis. Said positioning means may comprise the upstanding flange fitting in the scallop.

Alternatively, said teat may have an upstanding shoulder shaped to fit against said aperture of the collar, which shoulder is non-circular so that the teat only fits in the collar, with said shoulder abutting the edge of said aperture in one, or at most two, angular orientations of the teat in the collar with respect to said flange axis. Preferably, there is just one such angular orientation.

In accordance with a third aspect of the present invention there is provided a teat for a feeding bottle comprising a container, having a neck, and an annular collar, wherein the teat is suitable for assembly with the container and collar into a feeding bottle, and wherein the teat is adapted to be retained by the collar and sealed with respect to the neck of the container when the collar is connected to the neck of the container, the teat comprising:

an annular flange, having a flange axis;

a body extending inwardly from the flange;

a nipple surmounting the body and remote from the flange;

a feed opening at the end of the nipple, adapted to dispense feed when contained in the bottle; and

a shoulder surrounding the body and adapted in use to abut an edge of the aperture of the collar; wherein
the nipple has a nipple axis that is eccentric with respect to the flange axis and defines with the flange axis a plane of symmetry, and the shoulder has
a flat sector lying in a first plane and extending a first degree around the flange axis on either side of the plane of symmetry around the nipple axis; and
an inclined sector lying in a second plane extending a second degree around the flange axis on each side of the plane of symmetry and remote from the nipple axis,
which second plane is inclined with respect to the first plane.

Preferably, the first plane is substantially parallel the flange. Preferably, the flat sector extends between 200 and 300 degrees and the inclined sector extends between 60 and 160 degrees. More preferably, the flat sector extends between 260 and 280 degrees and the inclined sector extends between 80 and 100 degrees.

Preferably, the inclined sector is inclined by between 20 and 60 degrees. Preferably, there is a curved transition between the sectors extending over 10 or more than 10 degrees of rotation, preferably 20 or more than 20 degrees of rotation about said flange axis.

Preferably, a non-return valve is in the body between the nipple and the flange intersecting the middle of the inclined sector of the shoulder. Preferably, the non-return valve comprises a depression provided with an upstanding flange above the surface of the body, which flange serves to protect the depression against deformation of the main surface of the teat.

### BRIEF DESCRIPTION OF THE DRAWINGS

An embodiment of the invention is further described hereinafter, by way of example, with reference to the accompanying drawings, in which:

FIGS. 1a to 1e are respectively, a perspective view, a top view, a side view, a front view and another perspective view of an assembled feeding bottle in accordance with the invention;

FIGS. 2a to 2e are respectively, a perspective view, a top view, a side view, a front view and a section of a container suitable for use in a bottle such as illustrated in FIG. 1;

FIGS. 3a to 3g are respectively, a perspective view, another perspective view, a perspective underneath view, a top view, a side view, a front view, a section and an underneath view of a collar suitable for use in a bottle such as illustrated in FIG. 1;

FIGS. 4a to 4e are respectively, a perspective view, a section, a top view, a side view and a bottom view of a teat in accordance with the invention and suitable for use in a bottle such as illustrated in FIG. 1.

### DETAILED DESCRIPTION

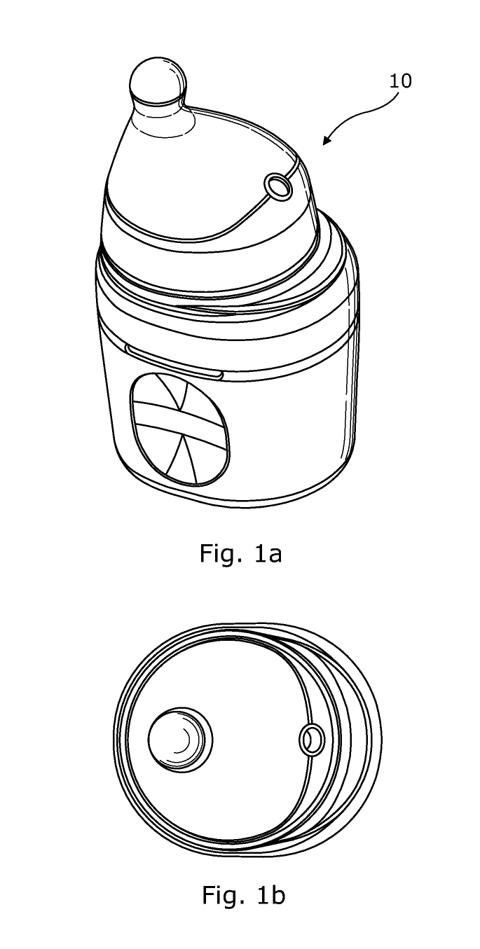

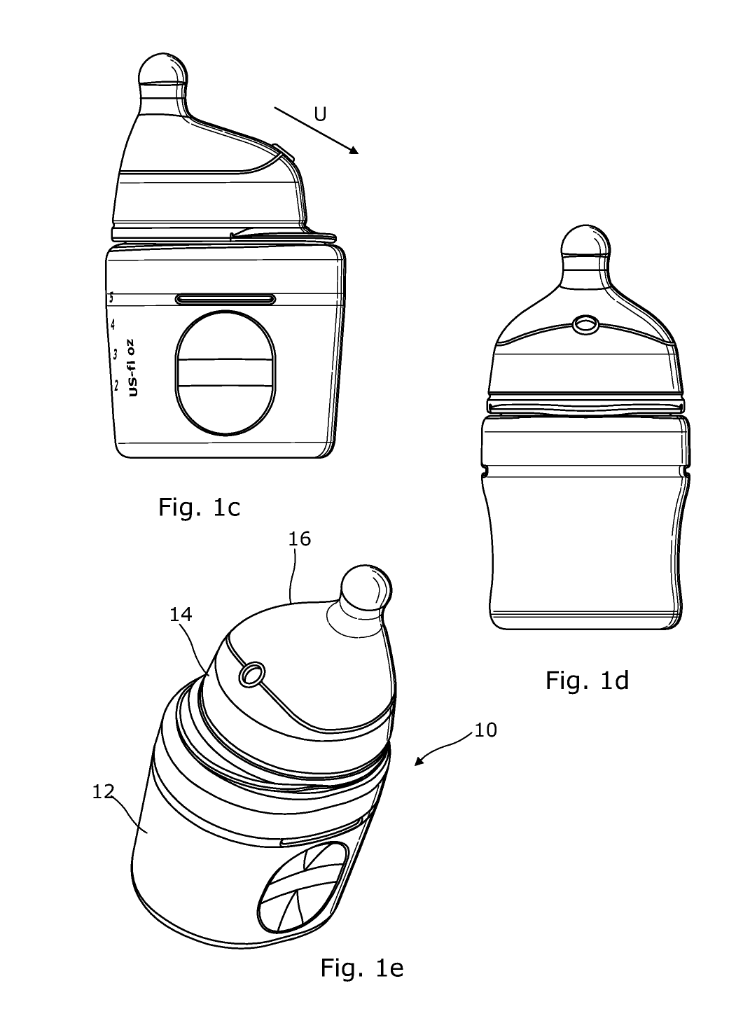

In FIG. 1, a feeding bottle 10 in accordance with the invention comprises a container 12, a collar 14 and a teat 16.

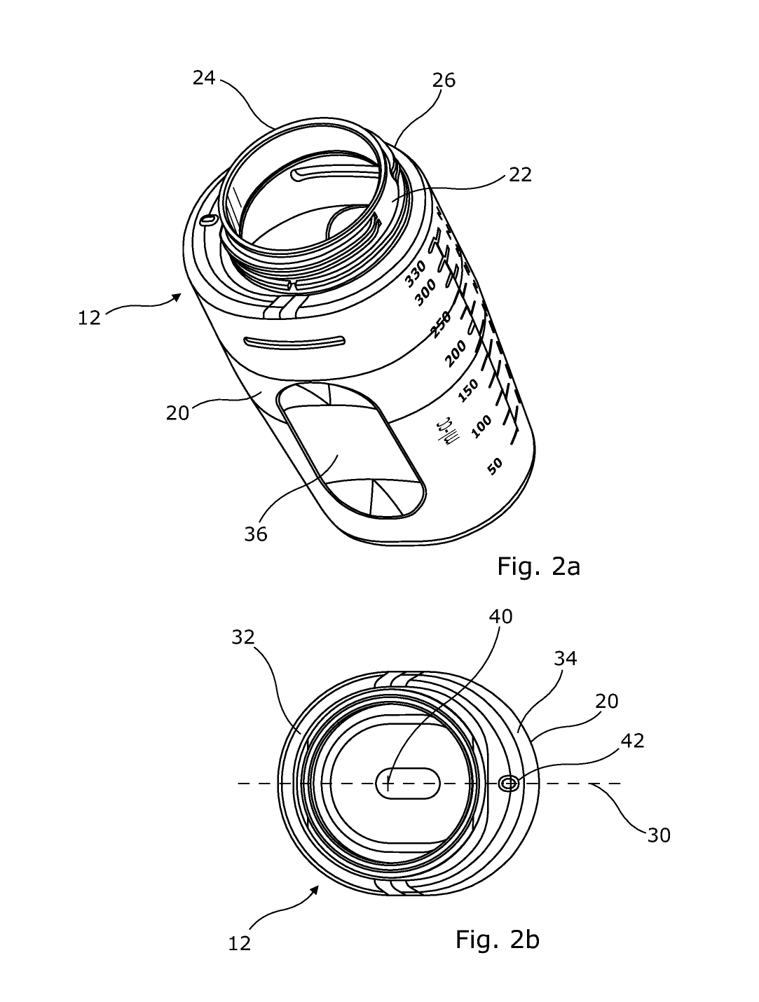

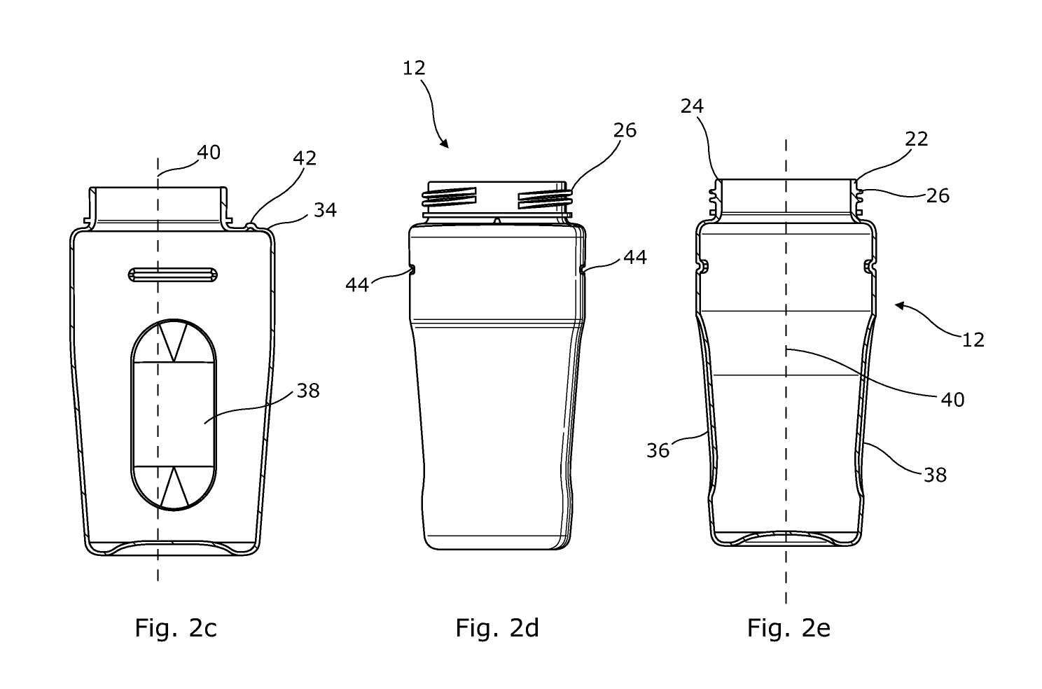

Turning to FIG. 2, the container 12 has a main part 20 and a threaded neck 22. The main part is a flattened oval in section, best seen in FIG. 2b, so that it has a single container plane 30 of symmetry. The neck as a circular rim 24 and a thread 26 with a single start point. The container 20 has two “ends” 32/34 to its oval section with the neck being at one end 32 so that a distinct shoulder 34 is formed at the other end of the section at the top of the container. The neck has a central axis 40 which also forms an approximate longitudinal axis of the container.

Depressions 36, 38 are formed in the sides of the container. These provide useful gripping areas for the container, reducing the span required between fingers and thumb to grip the container. Indeed, the flattened oval section of the container and the depressions 36,38 both conspire to encourage gripping of the container so that the container plane 30 tends to locate parallel to and between the arms of the “U” of a person's grip; that is, if the curve from fingers round to thumb can be considered approximately U-shaped.

The shoulder 34 further comprises a container detent 42 in the form of a pimple (although it could equally be a dimple). The container also includes side detents 44 adapted to retain the edge of a cap (not shown).

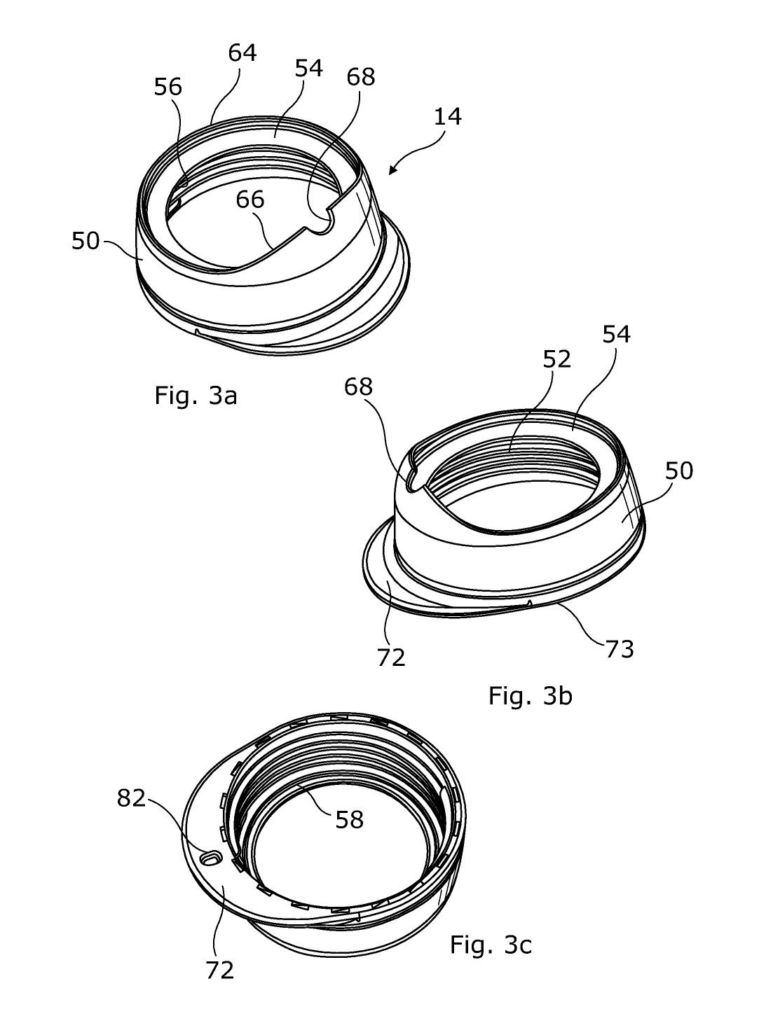

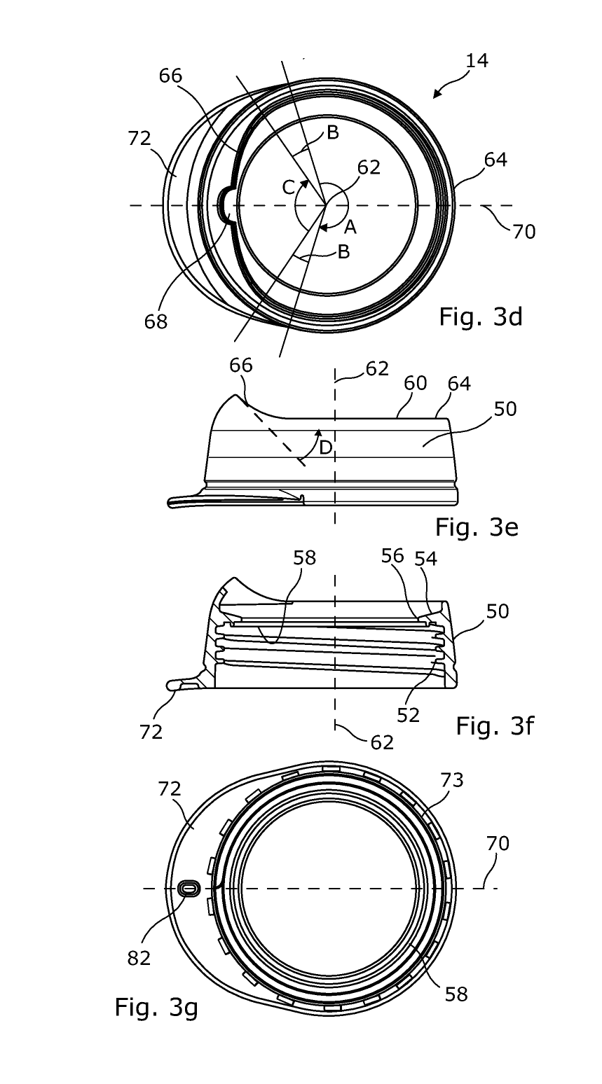

Turning to FIG. 3, the collar 14 comprises a cylindrical threaded sleeve 50 having a thread 52 matching the thread 26 of the container 12. The thread 52 has a thread axis 62. A rim 54 “closes” the sleeve 50; the rim has a central aperture 56 with a downwardly depending lip 58, which is circular and whose diameter closely matches the diameter of the rim 24 of the container 12. The sleeve 50 also has an upstanding edge 60 which is largely circular and lies in a flat plane perpendicular to the thread axis 62. However, it only extends around a flat sector 64 of an angle A around the thread axis 62 before transitioning over angles B into an inclined sector 66, which is inclined to the flat sector by an angle D. The inclined sector extends around the thread axis 62 over an angle C. The angles A to D are (in degrees of angle) approximately: A=210, B=20, C=110 and D=50. As such, the collar 14 is only symmetrical across one collar plane 70. The inclined sector 66 includes a scallop 68 at its peak, across the collar plane 70.

Symmetrically across that plane 70, the collar also has an external flange 72 extending from its periphery 73 remote from the upstanding edge 60. Under the external flange 72 is formed a flange detent 82 which corresponds with the container detent 42 in the sense of being complimentary thereto, as is explained further below.

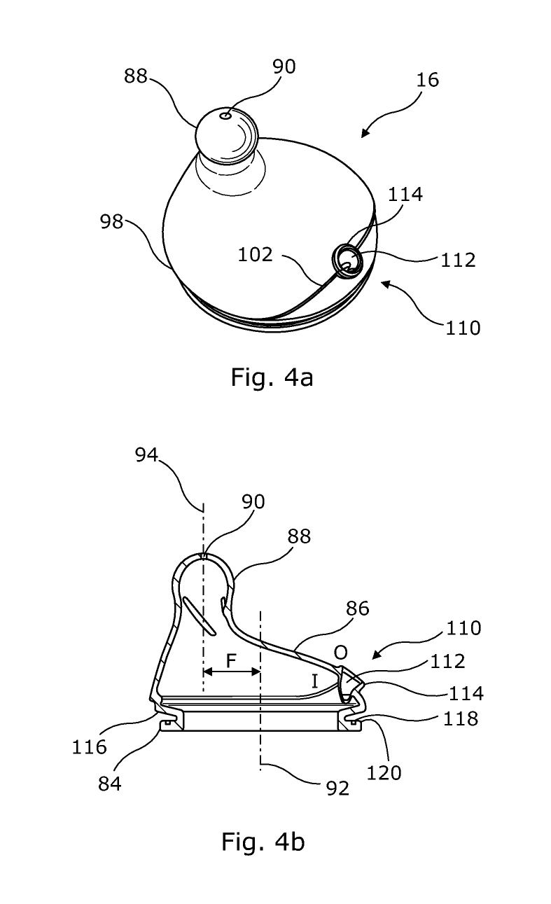

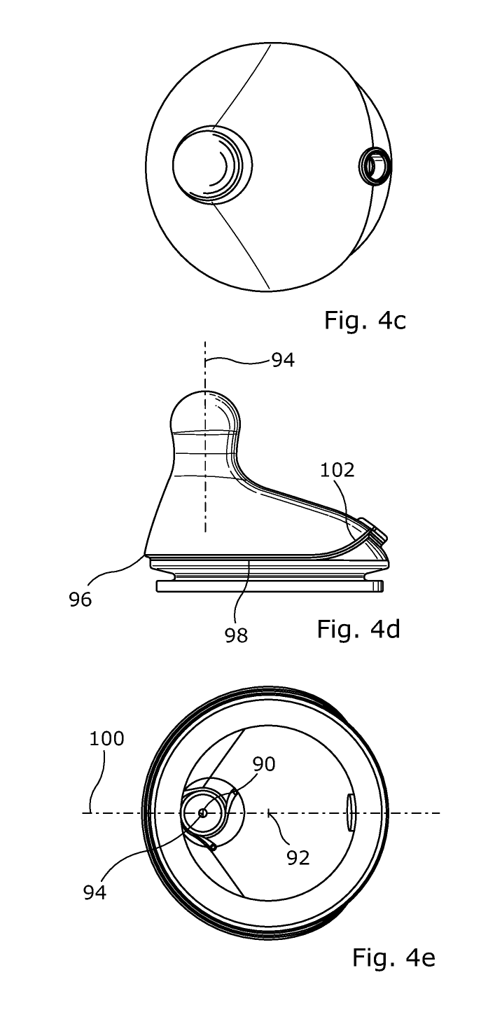

Finally, turning to FIG. 4, the teat 16 comprises a base flange 84 from which extends a bulbous body 86 that converges on a nipple 88 provided with a terminal feed opening 90. The flange 84 is circular and has a central flange axis 92. The nipple has a nipple axis 94 that is not concentric with the flange axis 92. In fact, it is parallel thereto and displaced by an offset F which is less than the radius of the flange 84. It is feasible that the nipple axis could be at any selected angle but in this embodiment it defines a teat plane of symmetry 100.

The teat 16 has a shoulder 96 that corresponds with the upstanding edge 60 of the collar 14 and likewise has a flat sector 98 and an inclined sector 102, extending around the same angles around the flange axis 92. In the centre of the inclined sector 102, in the teat plane 100, is a non-return valve 110. The non-return valve comprises a depression 112 at the base of which is a slit (not visible). The material of the teat is an elastomer such that the slit is normally closed, but opens when a negative pressure differential exists across it. That is, when the pressure is greater on the outside (O) of the teat compared with the pressure inside (I) of the teat. A pressure differential in the opposite direction (positive) tends to close the valve more tightly. Since the material of the teat is flexible, manipulation of it can tend to open the valve even when the pressure differential is positive. To counter this effect, an upstanding flange 114 is provided that surrounds the depression.

To assemble the bottle the teat 16 is inserted in the aperture 56 of the rim 54 until most of the body 86 is above the rim 54 which fits into a circular groove 116 formed around the teat. A circular channel 118 is on the top surface 120 of the flange 84 that seats around the lip 58 of the collar rim 54. The teat 16 only fits with one orientation in the collar 14 so that the collar thread axis 62 coincides with the teat flange axis 92. Moreover, the teat plane 100 is coincident with the collar plane 70 and the upstanding flange 114 around the depression 112 of the valve 110 fits into the scallop 68. The scallop 68 and the upstanding edge 64 of the collar at its inclined sector 66 overlies the body 86 of the teat in the region of the valve further lending it support. Thus, the assembled teat and collar form a unit having a single combined plane of symmetry 100/70.

The collar is then screwed onto the neck 22 of the container 12 and the threads are arranged with two effects. The first is that the threads 26/52 begin to engage when the external flange 72 of the collar overlies the opposite side of the shoulder 34 of the container. Thus the user knows without trial where to offer the collar to the container (that is, the required angular orientation between them) to begin connection. Secondly, the threads are arranged so that the flange 84 is squeezed (sealingly tight) between the lip 58 of the rim 54 of the collar 14 and the rim 24 of the neck 22 of the container 12 when the collar has been turned through half a complete revolution around the flange/collar/neck axes 92/62/40 (which are all now coincident) and so that the external flange 72 of the collar again overlies the shoulder 34. However, now the collar has advanced down the thread 26 so that the flange 72 contacts the detent 42 and presses against it with increasing force until the precise alignment of the planes of symmetry 100/70 of the collar and teat coincide with the container plane 30, whereupon the detents 42/82 snap into engagement informing the user of correct and complete connection of the teat and collar to the container.

In order to accommodate tolerances in manufacture, as well as differences caused by component wear, particularly of the teat, several possibilities are possible. First and foremost, the flange 72 is arranged so that it does not overhang the edge of the container unless more than about 20 degrees of misalignment occurs between the planes 100/70. Thus, such minor misalignment can pass relatively unnoticed. Second, it may be preferred for this reason to omit the detent coupling 42/82. Alternatively, several detents 42 (or 82) could be provided whereby there might be several clicks as the detents engage and disengage on tightening.

In any event, with the aforementioned arrangement, it is now provided that the nipple 88 of the teat is close to the end 32 of the oval section of the container so that, in the assembled bottle as shown in FIG. 1, the nipple is close to the edge of the bottle and is convenient to feed from for an infant. Moreover, it is aligned with the plane of grip 30 facilitating operation by the infant carer. Finally, the non-return valve is arranged reliably upmost when the bottle is used in its intended feeding position (Arrow U in FIG. 1c illustrating a typical orientation of the bottle during feeding, where the arrow points vertically upward and the longitudinal axis of the bottle is inclined by about 35 degrees to the horizontal).

The foregoing description is of a bottle having a single plane of symmetry. An infinite number of planes of symmetry is outside the scope of the present invention, since the present invention is predicated on there being a preferred plane of orientation (plane of grip). However, while this preferred plane of orientation is singular with respect to the nipple of the teat, there are several possibilities for the container that may have more than one convenient gripping plane. Consequently, it is within the ambit of the present invention that the container may be able to fit the collar and teat in more than one orientation.

Indeed, while it is described above that the collar is screw-threaded onto the container, this is not essential. Other means of separable connection are within the ambit of the present invention. For example, click-fit, or snap-fit, collars are feasible, provided they apply sufficient pressure on the flange of the teat to effect a seal. In this respect, the collar, teat and neck may well not be circular. Indeed, non-circular shapes facilitate a snap-on, twist-off mode of operation to be employed for connection and separation of the collar and container.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A feeding bottle comprising:
a container, having a longitudinal axis and a neck around an opening of the container, wherein the neck comprises a first connector part and has a neck axis;
a teat, having:
a flange, adapted to seat on said neck and having a flange axis to coincide with said neck axis when the teat is seated on the neck;
a nipple, remote from the flange,
a feed opening at an end of the nipple adapted to dispense feed when contained in the bottle,
a depression in a main surface of the teat between the flange and the nipple, and
a one-way valve formed in the teat in the depression to allow the passage of air into the container but prevent leakage of liquid from the container through the valve; and,
an annular collar, having:
an aperture adapted to receive said teat,
a second connector part, and,
a rim around said aperture adapted to press said flange against said neck to seal the teat with respect to the container when said first and second connector parts are interengaged with one another to connect the collar to the container,
in which the depression is inside said aperture when the bottle is assembled and is provided with an upstanding flange above the surface of the teat where the depression joins a main surface of the teat, which flange serves to protect the depression against deformation of the main surface of the teat.

2. A feeding bottle as claimed in claim 1, wherein the aperture of the annular collar has a scallop in its edge adapted to receive said upstanding flange.

3. A feeding bottle as claimed in claim 1, comprising positioning means arranged so as to ensure that the teat only fits in the collar in one angular orientation of the teat about said flange axis.

4. A feeding bottle as claimed in claim 3, wherein said positioning means comprises the upstanding flange fitting in the scallop.

5. A feeding bottle as claimed in claim 4, wherein said teat has an upstanding shoulder shaped to fit against said aperture of the collar, which shoulder is non-circular so that the teat only fits in the collar, with said shoulder abutting the edge of said aperture in one, or at most two, angular orientations of the teat in the collar with respect to said flange axis.
